(19) United States
(12) Patent Application Publication
(10) Pub. No.: US 2012/0249751 A1
(43) Pub. Date: Oct. 4, 2012

(54) IMAGE PAIR PROCESSING

(75) Inventors: Tao Zhang, Sunnyvale, CA (US); Dong Tian, Plainsboro, NJ (US)

(73) Assignee: THOMSON LICENSING, Issy Les Moulineaux (FR)

(21) Appl. No.: 13/515,645

(22) PCT Filed: Dec. 10, 2010
(86) PCT No.: PCT/US10/03139

§ 371 Date: Jun. 13, 2012

Related U.S. Application Data
(60) Provisional application No. 61/284,152, filed on Dec. 14, 2009.

(51) Int. Cl. H04N 13/02

(52) U.S. Cl. 348/47; 348/E13.074

(57) ABSTRACT

At least one implementation determines whether two cameras are in parallel or are converging, based on an automated analysis of images from the cameras. One particular implementation determines the disparity of a foreground point and a background point. If the sign of the two disparities are the same, then the particular implementation decides that the cameras are in parallel. Otherwise, the particular implementation decides that the two cameras are converging. More generally, various implementations access a first image and a second image that form a stereo image pair. Multiple features are selected that exist in the first image and in the second image. An indicator of depth is determined for each of the multiple features. It is determined whether the first camera and the second camera were arranged in a parallel arrangement or a converging arrangement based on the values of the determined depth indicators.

### CROSS-REFERENCE TO RELATED APPLICATIONS

This application claims the benefit of the filing date of the following U.S. Provisional Application, which is hereby incorporated by reference in its entirety for all purposes: Ser. No. 61/284,152, filed on Dec. 14, 2009, and titled “Method to Detect Whether a Stereo Image Pair are in Parallel or Convergent”.

### TECHNICAL FIELD

Implementations are described that relate to three-dimensional video. Various particular implementations relate to processing stereo image pairs.

### BACKGROUND

During 3D image/video acquisition, the cameras or image sensors may be arranged in parallel or converging positions. Similarly, when generating 3D computer graphics contents, the virtual cameras may be arranged in parallel or converging positions. Unfortunately, information identifying the camera arrangement/position may be not available when images from the cameras are presented due to, for example, a lack of metadata from the content producer or because the images are altered by a third party.

### SUMMARY

According to a general aspect, a first image and a second image are accessed. The first and second images form a stereo image pair. The first image has been captured from a first camera, and the second image has been captured from a second camera. The first and second cameras are in either a parallel arrangement or a converging arrangement. Multiple features are selected that exist in the first image and in the second image. An indicator of depth is determined for each of the multiple features. It is determined whether the first camera and the second camera were arranged in the parallel arrangement or the converging arrangement based on the values of the determined depth indicators.

The details of one or more implementations are set forth in the accompanying drawings and the description below. Even if described in one particular manner, it should be clear that implementations may be configured or embodied in various manners. For example, an implementation may be performed as a method, or embodied as an apparatus, such as, for example, an apparatus configured to perform a set of operations or an apparatus storing instructions for performing a set of operations, or embodied in a signal. Other aspects and features will become apparent from the following detailed description considered in conjunction with the accompanying drawings and the claims.

### BRIEF DESCRIPTION OF THE DRAWINGS

FIG. 1 is a diagram depicting an example of two cameras arranged in parallel positions.

FIG. 2 is a diagram depicting an example of two cameras arranged in converging positions.

FIG. 3 is a block/flow diagram depicting an example process for determining if a stereo image pair is from parallel or converging cameras.

FIG. 4 is a diagram depicting the selection of common regions in a stereo image pair.

FIG. 5 is a block/flow diagram depicting an example of an encoding system that may be used with one or more implementations.

FIG. 6 is a block/flow diagram depicting an example of a decoding system that may be used with one or more implementations.

FIG. 7 is a block/flow diagram depicting an example of a video transmission system that may be used with one or more implementations.

FIG. 8 is a block/flow diagram depicting an example of a video receiving system that may be used with one or more implementations.

FIG. 9 is a block/flow diagram depicting another example process for determining if a stereo image pair is from parallel or converging cameras.

### DETAILED DESCRIPTION

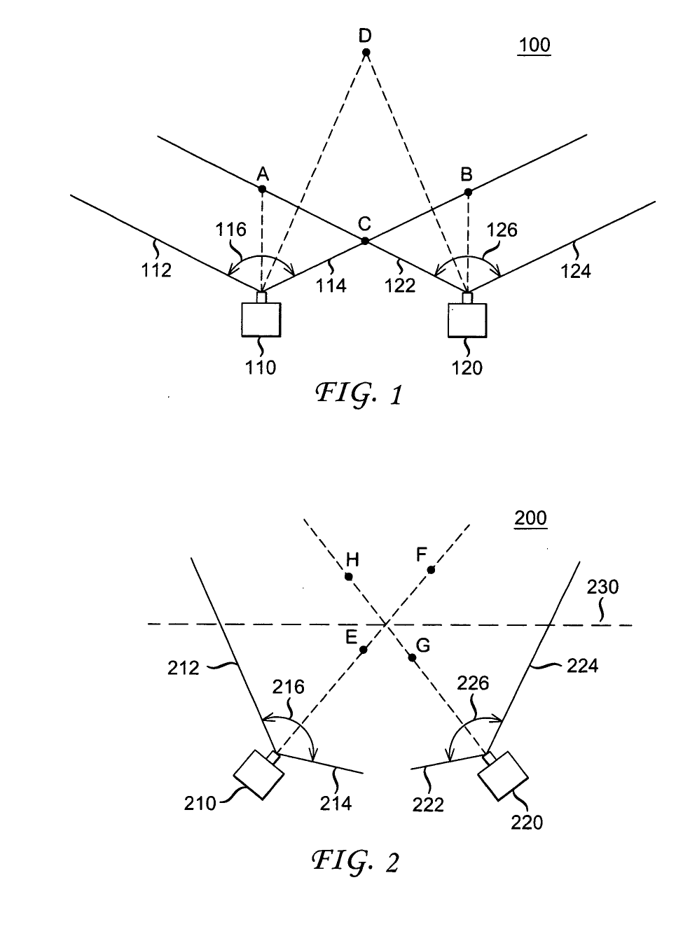

At least one implementation in this application describes an algorithm to determine whether a given pair of images, such as, for example, a stereo image pair, or two images from a multi-view system, shall be regarded as having been captured by parallel cameras or converging cameras. This implementation examines the disparity of a point in the foreground and a point in the background. If the two disparity values have the same sign, then the cameras are assumed to be in parallel, as shown in FIG. 1 which is explained further below. Conversely, if the two disparity values have different signs, then the cameras are assumed to be converging, as shown in FIG. 2 which is explained further below.

3D image/video contents may be generated by, for example, stereo-image cameras, multiview cameras, or rendered by a cluster of virtual cameras based on technologies of computer graphics from different viewpoints. Common methods to arrange two cameras or virtual cameras are in parallel positions or converging positions. Multiview cameras can be thought of consisting of a group of adjacent camera pairs.

A 3D video clip may be generated using parallel cameras and/or using converging cameras, including alternately using both parallel and converging cameras. The knowledge on how a piece of 3D content was generated may be useful at a later stage in a 3D production chain, such as, for example, post production, compression, and rendering. Such knowledge generally includes important camera parameters, for example, camera intrinsic parameters and camera extrinsic parameters. It is possible to record the information as metadata for each pair of frames and pass the metadata along the 3D production chain. Unfortunately, the 3D video industry appears to lack a universal method to maintain such metadata all through the 3D production chain, which may result in the metadata becoming unavailable. The decision as to whether to keep the metadata is typically made by the camera manufacturers or the 3D content creators. Another potential cause for losing such metadata is that the 3D content is modified in a way that invalidates the original metadata. Moreover, in some instances various metadata or parameters are kept and maintained, but such metadata or parameters are not made available to all users who want to use the metadata or parameters. For example, for computer graphics 3D content, such as, for example, 3D animation films, the parameters are generally known to the producer, but most users who want to use these parameters simply cannot access them. Additionally, if photo cameras are used to generate a pair of stereo images by shooting twice with a small displacement, such information may be unavailable unless special equipment is used.

One of the important pieces of information which can be obtained from these parameters is whether a pair of stereo images was produced by parallel or converging cameras. The information on camera arrangement may be useful in many applications. Content generated by parallel cameras or converging cameras may produce different types of distortions and/or 3D effects. For example, keystone distortion will be present in 3D content generated by converging cameras, although not in 3D content generated by parallel cameras. Particular processing methods thus can be applied by being aware of the camera arrangement. Multiple implementations are described for determining the camera arrangement.

In a first implementation, the camera arrangement is determined solely by checking the image. With this first implementation, the determination may be done manually, as follows.
1. We select a point in one image with its coordinates in the image plane available.
2. We locate the corresponding point in the other image with its new coordinate being identified.
3. We compute the difference between the two coordinates, and the difference is referred to as correspondence or disparity. The disparity, thus, quantifies the movement of the “point” (for example, a corner of an object) when viewed in the two different images.
4. Operations 1-3 are performed for different points, or at least two points, in the image. In one particular implementation, we check the correspondence for the point corresponding to a 3D point that is closest to, the camera, referred to as dₙ, and for the point corresponding to a 3D point that is farthest from, the camera, referred to as d_{f}. Note that other implementations check the correspondence for points near to, and far from, the camera, although not necessarily the points closest to, and farthest from, the camera.
5. If both dₙ and d_{f} are positive or negative, it is determined that the cameras are arranged in parallel. Otherwise, if they exhibit different signs, it is determined that the cameras are not in parallel but, rather, are in converging positions.

The manual method can be explained with reference to FIGS. 1 and 2. Referring to FIG. 1, a system 100 includes a first camera 110 and a second camera 120 arranged in a parallel configuration. The camera 110 has a viewing angle 111 bounded by a left border 112 and a right border 114. The camera 120, similarly, has a viewing angle 121 bounded by a left border 122 and a right border 124.

Point A is positioned directly in the middle of the viewing angle 111 of the camera 110, as shown by the dashed line connecting point A with the camera 110. The position of point A is also on the left border 122 of the camera 120. It should be clear that point A is in the middle of an image taken with the camera 110, but is on the left border of an image taken with the camera 120. Thus, the disparity for point A is a value that indicates movement to the left from the camera 110 to the camera 120, assumed in this implementation to be a negative value.

Point B, conversely, is positioned directly in the middle of the viewing angle 121 of the camera 120, as shown by the dashed line connecting point B with the camera 120. The position of point B is also on the right border 114 of the camera 110. It should be clear that point B is in the middle of an image taken with the camera 120, but is on the right border of an image taken with the camera 110. Thus, the disparity for point B is a value that indicates movement to the left from the camera 110 to the camera 120. The disparity for point B will be a negative value, following the same assumption for point A, and because points A and B both indicate movement in the same direction.

Point C is positioned on the right border 114 of the camera 110. Point C is also on the left border 122 of the camera 120. It should be clear that point C is on the right border of an image taken with the camera 110, but is on the left border of an image taken with the camera 120. Thus, the disparity for point C is a value that indicates movement to the left from the camera 110 to the camera 120. The disparity for point C will be a negative value, following the same assumption for point A, and because points A and C both indicate movement in the same direction.

Point D is not positioned on a border or in the middle of a viewing angle. Rather, point D is positioned to the right of center of an image taken with the camera 110, but is positioned to the left of center of an image taken with the camera 120. Thus, the disparity for point D is a value that indicates movement to the left from the camera 110 to the camera 120. The disparity for point D will be a negative value, following the same assumption for point A, and because points A and D both indicate movement in the same direction.

Thus, each of points A-D has a disparity value that is negative. The absolute magnitude of the disparity values of points A-D varies, however the sign does not vary. Similar results can be seen to occur for any point that is in the viewing angle of both the camera 110 and the camera 120.

Referring to FIG. 2, a system 200 includes a first camera 210 and a second camera 220 arranged in a converging configuration. The camera 210 has a viewing angle 211 bounded by a left border 212 and a right border 214. The camera 220, similarly, has a viewing angle 221 bounded by a left border 222 and a right border 224.

Point E is positioned directly in the middle of the viewing angle 211 of the camera 210, as shown by the dashed line connecting point E with the camera 210. The position of point E is also to the left of center in the viewing angle 221 of the camera 220. Thus, the disparity for point E is a value that indicates movement to the left from the camera 210 to the camera 220, assumed in this implementation to be a negative value.

Point F is, as with point E, positioned directly in the middle of the viewing angle 211 of the camera 210, as shown by the dashed line connecting point F with the camera 210. The position of point F is also to the right of center in the viewing angle 221 of the camera 220. Thus, the disparity for point F, in contrast to the disparity for point E, is a value that indicates movement to the right from the camera 210 to the camera 220. The disparity for point F will be a positive value, following the same assumption for point E, and because points E and F indicate movement in opposite directions.

Point G is positioned directly in the middle of the viewing angle 221 of the camera 220, as shown by the dashed line connecting point G with the camera 220. The position of point G is also to the right of center in the viewing angle 211 of the camera 210. Thus, the disparity for point G is a value that indicates movement to the left from the camera 210 to the camera 220. The disparity for point G will be a negative value, following the same assumption for point E, and because points E and G both indicate movement in the same direction.

Point H is, as with point G, positioned directly in the middle of the viewing angle 221 of the camera 220, as shown by the dashed line connecting point H with the camera 220. The position of point H is also to the left of center in the viewing angle 211 of the camera 210. Thus, the disparity for point H, in contrast to the disparity for point G, is a value that indicates movement to the right from the camera 210 to the camera 220. The disparity for point H will be a positive value, following the same assumption for point E, and because points E and H indicate movement in opposite directions.

Thus, each of points E and G has a disparity value that is negative. However, each of points F and H has a disparity value is positive. It can be readily determined that the disparity value is (i) zero for any point positioned on a horizontal dashed line 230, (ii) negative for any point positioned below the line 230 (closer to the cameras 210 and 220), and (iii) positive for any point positioned above the line 230 (farther from the cameras 210 and 220). Accordingly, for converging cameras, as in FIG. 2, foreground points will have negative disparity values if those points are sufficiently close to the cameras, and background points will have positive disparity values if those points are sufficiently far from the cameras.

This manual method is carried out by subjective observation and is effective and useful in many applications. However, this manual method may frequently be time-consuming and inefficient and, hence, may not be practical for processing a large number of stereo image pairs.

A second implementation to determine the camera arrangement involves checking the rotation matrices of the two cameras, which should be parameterized relative to the same world coordinate system. If both cameras have identical rotation matrices, it can be determined that the cameras are arranged in parallel. Otherwise, it can be determined that the cameras are arranged in converging positions. This implementation is effective, and is useful in many applications. However, this implementation generally requires that the extrinsic camera parameters be available. Extrinsic camera parameters may be estimated using, for example, marker-based methods before capturing images. Marker based methods are generally done before shooting (capturing the images) by putting markers, such as, for example, a checkerboard with known sizes, in the background. Alternatively, extrinsic camera parameters may be estimated using, for example, an auto-calibration process after capturing the images. However, an auto-calibration has limitations that might be important for various applications. For example, an auto-calibration generally needs to process a large number of frames to have a better estimation, and does not work on a single frame. Additionally, often auto-calibration does not yield a unique estimation result due to local optimum problems. Further, it should be noted that classical calibration/estimation methods require markers such as checkerboard and are performed before shooting (capturing images). Thus, such classical methods are not well-suited to the problem of determining camera arrangement using only images that are shot (captured) without any markers in the background.

A third implementation uses the same principle as the manual method described in the first implementation above to determine if camera pairs are parallel or converging. However, this third implementation uses automatic feature selection and matching processes to replace the manual process. This third implementation is typically simple, fast, and accurate.

Features generally refer to some characteristics that do not change under certain transformations. Features that have been frequently used in computer vision applications include, for example, geometric primitives such as, for example, points, lines, or regions. For example, corner points may be used as point features, and lines on an object such as edges may be used as line features. When the same feature appears in different images, a feature matching process will establish the correspondence between the same features among the different images. For example, after feature matching, we know (that is, we have determined) that a feature point in one image is the same feature point in another image. Feature matching generally consists of two steps. The first step is feature detection (or selection, or identification), and detects features in images. The second step is feature matching, and establishes correspondences between detected features from different images according to some criteria.

Feature tracking is a similar process that can establish feature correspondence. A feature tracking process generally detects features in the first image, then uses the locations of the detected features from the first image as an initial estimation of the locations of the same features in the second image. For each initial estimation, the feature tracking process then searches the surrounding regions in the second image (surrounding the initial location estimate) for a match to the feature from the first image. Feature tracking is often used when the changes (such as feature displacement) between two images are not large.

Thus, feature matching is used, generally, by detecting features in two images and then using a separate matching process without knowing the correspondence between features of the two images. The matching process attempts to find the correspondence, one feature at a time. Note that the geometric transformation between these features may be very significant, and the scaling may be quite large. In contrast, feature tracking is used, generally, by detecting features in a first image, and then using a separate searching process to find a local match in the second image.

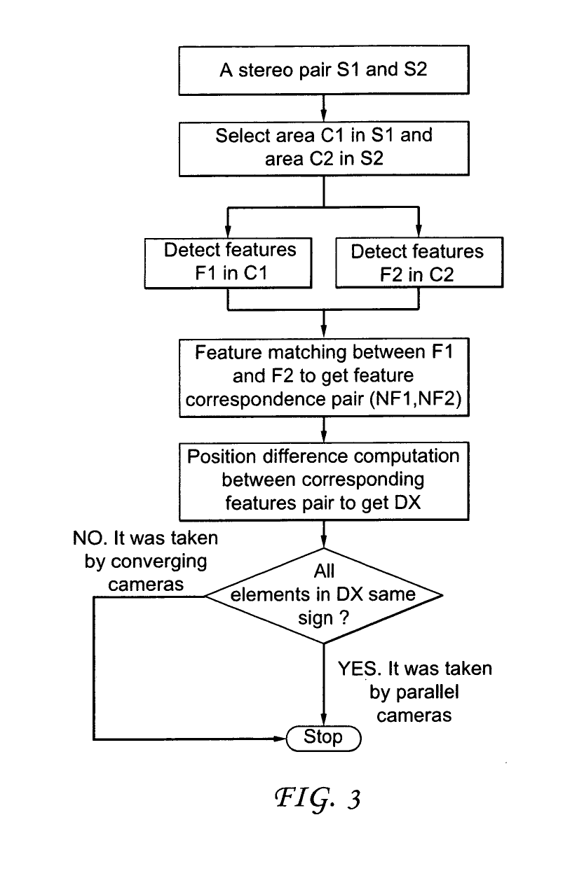

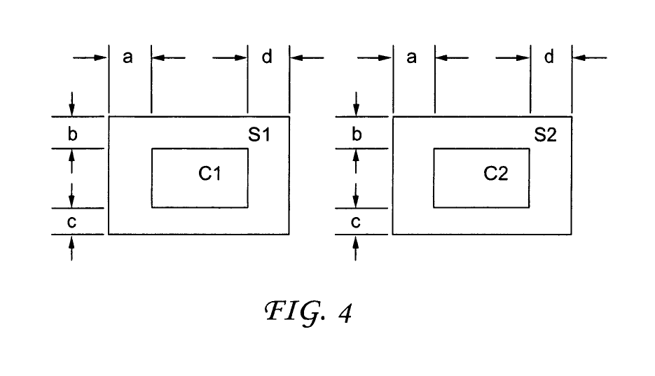

An algorithm for one variation of the third implementation is given below and shown in FIG. 3.
1. The input is a stereo pair of images denoted by S₁ for the first image, and S₂ for the second image (operation 310). Assume dimension is width times height.
2. Select common areas in S1 and S2, that is, the area of overlap, which are denoted by C₁ and C₂ (operation 320). See also FIG. 4 for more detail, which is explained further below.
3. Perform feature detection in C₁ and C₂ (operations 330 and 340). Let the resulting features in C₁ be

F1={F1ᵢ|i=1 . . . n₁} (1)
and the resulting features in C₂ be

F2={F2ᵢ|i=1 . . . n₂} (2)
respectively. Where n₁ and n₂ are the number of features found.
Note that operations 3 and 4 are a high level description applicable with any feature detection and correspondence methods.
4. Find feature correspondences (matching) between F1 and F2 (operation 350). The feature matching process will remove those features in one image with no correspondence in another image. Let the new (remaining) feature points in C₁ be

NF1={NF1ᵢ|i=1 . . . N} (3)
and the new feature points in C₂ be

NF2={NF2ᵢ|i=1 . . . N} (4)
where N is the total number of features having correspondences. (NF1ᵢ, NF2ᵢ) is a pair of matching points in S₁ and S₂.
5. Let the positions of corresponding feature points NF1ᵢ be (xᵢ₁,yᵢ₁) and NF2ᵢ be (xᵢ₂,yᵢ₂). The positions are relative to a common point in both images, such as the top-left corner being used as the origin. Compute the set of position differences (operation 360), described by

DX={DXᵢ=x₁ᵢ−x₂ᵢ|i=1 . . . N}. (5)
6. Analyze DX to determine if the signs of elements in DX are the same (operation 370). If yes, then we decide that the input image pair was taken by parallel cameras. Otherwise, we decide that the input image pair was taken by converging cameras.

Selection of common areas C₁ and C₂ (operation 320) is illustratively depicted in FIG. 4. The values for “a”-“d” are used to control the area of overlap. In many implementations, the outer borders are ignored because the outer borders are assumed not to be part of the area of overlap. The outer borders include, for example, the area “a” in S1 and the area “d” in S2. Other implementations allow for separate values for “a”-“d” for each image. It is computationally inefficient, and indeed increases the chances of error, if non-overlapping regions from the left and right views are included in the areas designated as “areas of overlap”. The areas of overlap should include common objects, for example.

A variation of the third implementation uses feature tracking to determine the feature correspondence. In the algorithm, we used feature detection and feature correspondence computation to find matching features as shown in operations 330-350. However, feature matching can be implemented as feature tracking instead. As an example of a high level description of all feature tracking methods, consider the following implementation:
a. Compute features in C.
b. Use features computed in C₁ as initial feature positions in C₂, and track features in C₂.
c. The tracked features in C₂ correspond to the features in C₁. Features in C₁ for which tracking is lost in C₂ should be removed.

The above algorithm gives a high level description of how to use feature matching methods or feature tracking methods to detect whether a stereo image pair are parallel or convergent. Specific implementation details for feature matching or feature tracking methods are well known, and the present implementations are not restricted to any particular methods. Any feature matching method or feature tracking method can be used in the above algorithms. In one implementation, we use the KLT feature tracking method as given in the following references, which are each hereby incorporated by reference in their entirety for all purposes:
Bruce D. Lucas and Takeo Kanade, “An Iterative Image Registration Technique with an Application to Stereo Vision”, International Joint Conference on Artificial Intelligence, pages 674-679, 1981.
Carlo Tomasi and Takeo Kanade, “Detection and Tracking of Point Features”, Carnegie Mellon University Technical Report CMU-CS-91-132, April 1991.
   Other feature detections methods that can be used include, for example, a popular point feature detection method called the SIFT algorithm. The SIFT algorithm uses a multiple scale method to select points that are salient in all of the multiple scales used. A feature obtained by SIFT includes its position and a set of descriptors. When establishing feature correspondence, this set of features will be compared with that from other feature points to determine a best match. The literature, such as the following reference which is hereby incorporated by reference in its entirety for all purposes, describes different feature detection and matching methods:
David Lowe, “Object Recognition from Local Scale-Invariant Features”, Proceedings of the International Conference on Computer Vision, 1999.

Variations of the third implementation may use quality conditions. For example, the features that are selected in the feature detection stage may be limited to those features that satisfy one or more quality conditions. Quality conditions may include, for example, having a sufficient number of pixels in the feature to hopefully allow better matching/tracking. As another example, the feature matching may use one or more quality conditions. For example, features may be declared to be matched only if the match results in a sufficiently high confidence score, or if the candidate matched-features have an indicator of depth (for example, disparity) that is sufficiently far from zero so as to avoid errors in determining the sign of the indicator. Additionally, values for the depth indicator that are clearly in error may result in discarding that candidate matched-features pair.

Variations of the third implementation may use different numbers of detected and/or matched features. For example, one implementation uses a sufficiently large number of features, such that it is expected with a high degree of certainty that some features are in the foreground and some features are in the background. One implementation selects at least a threshold number of features, but less than all of the features that exist in the first image and in the second image. Another implementation selects the threshold number (or sufficiently large number) of features without regard to whether the features are in the foreground or the background. In one implementation, such a selection is accomplished by using a random selection.

It is understood that the algorithms presented might not always produce an accurate result. For example, depending on scene geometry, situations may arise in which the algorithms inaccurately predict that cameras are parallel. Additionally, depending on the number of features tested and the locations of those features, further situations may arise in which the algorithms inaccurately predict that cameras are parallel. However, the algorithms have proved exceptionally accurate over a large test sample that is believed to represent common camera and scene configurations. Additionally, it is believed that if the tested features produce different disparity signs, then the algorithms will always accurately predict the camera configuration as converging.

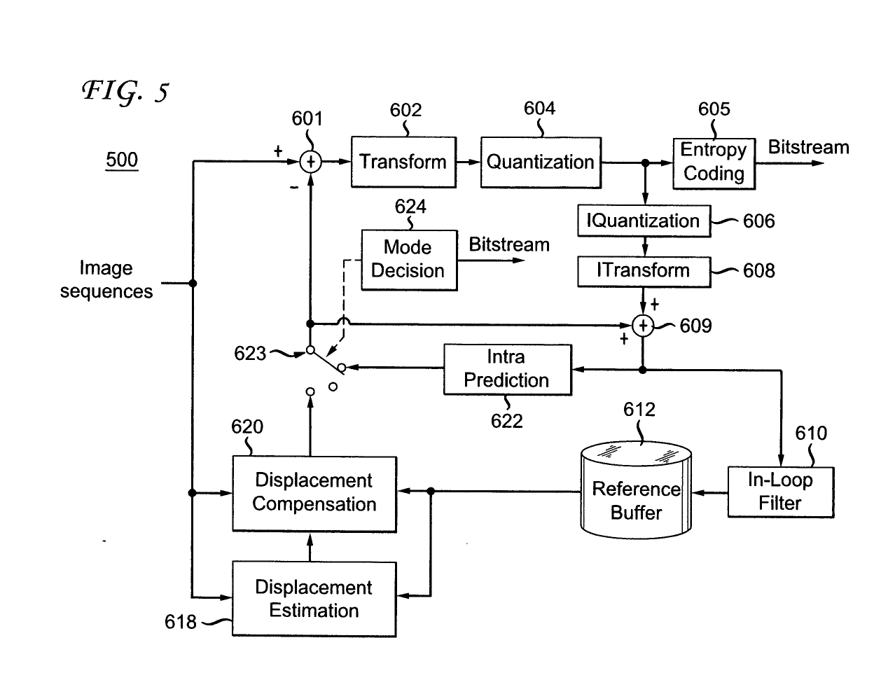

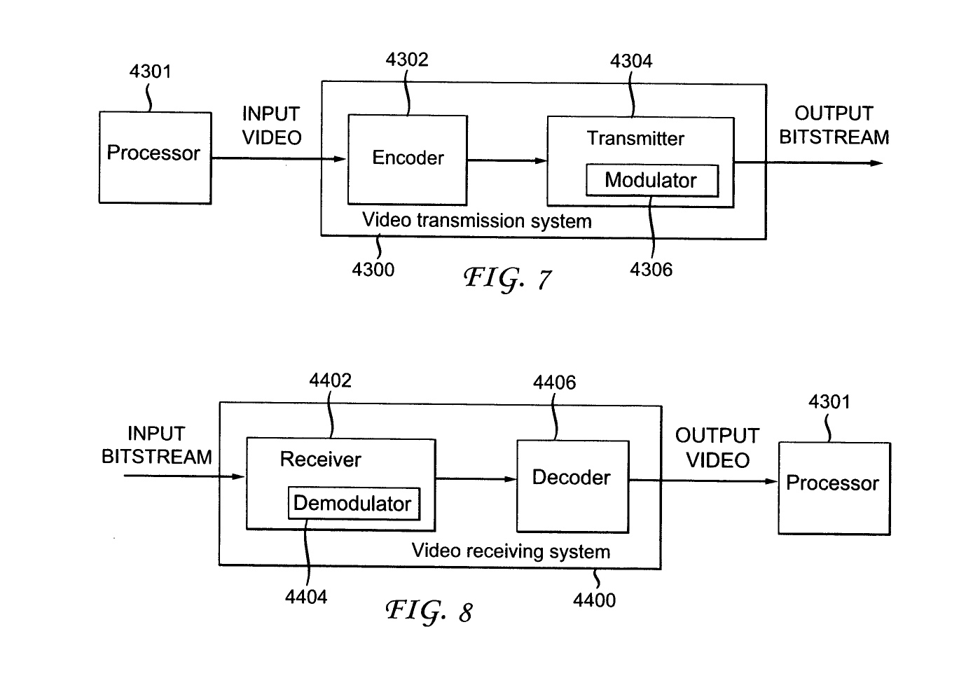

Referring to FIG. 5, an encoder 500 depicts an implementation of an encoder that may be used to encode images from, for example, a camera pair. The encoder 500 may also be used to encode, for example, metadata indicating whether the camera pair is converging or parallel. The encoder 500 may be implemented as part of a video transmission system as described below with respect to FIG. 7. An input image sequence arrives at adder 601 as well as at displacement compensation block 620 and displacement estimation block 618. Note that displacement refers, for example, to either motion or disparity. Another input to the adder 601 is one of a variety of possible reference picture information received through switch 623.

For example, if a mode decision module 624 in signal communication with the switch 623 determines that the encoding mode should be intra-prediction with reference to the same block or slice currently being encoded, then the adder receives its input from intra-prediction module 622. Alternatively, if the mode decision module 624 determines that the encoding mode should be displacement compensation and estimation with reference to a block or slice that is different from the block or slice currently being encoded, then the adder receives its input from displacement compensation module 620.

The adder 601 provides a signal to the transform module 602, which is configured to transform its input signal and provide the transformed signal to quantization module 604. The quantization module 604 is configured to perform quantization on its received signal and output the quantized information to an entropy encoder 605. The entropy encoder 605 is configured to perform entropy encoding on its input signal to generate a bitstream. The inverse quantization module 606 is configured to receive the quantized signal from quantization module 604 and perform inverse quantization on the quantized signal. In turn, the inverse transform module 608 is configured to receive the inverse quantized signal from module 606 and perform an inverse transform on its received signal. Modules 606 and 608 recreate or reconstruct the signal output from adder 601.

The adder or combiner 609 adds (combines) signals received from the inverse transform module 608 and the switch 623 and outputs the resulting signals to intra prediction module 622 and in-loop filter 610. Further, the intra prediction module 622 performs intra-prediction, as discussed above, using its received signals. Similarly, the in-loop filter 610 filters the signals received from adder 609 and provides filtered signals to reference buffer 612, which provides image information to displacement estimation and compensation modules 618 and 620.

Metadata may be added to the encoder 500 as encoded metadata and combined with the output bitstream from the entropy coder 605. Alternatively, for example, unencoded metadata may be input to the entropy coder 605 for entropy encoding along with the quantized image sequences.

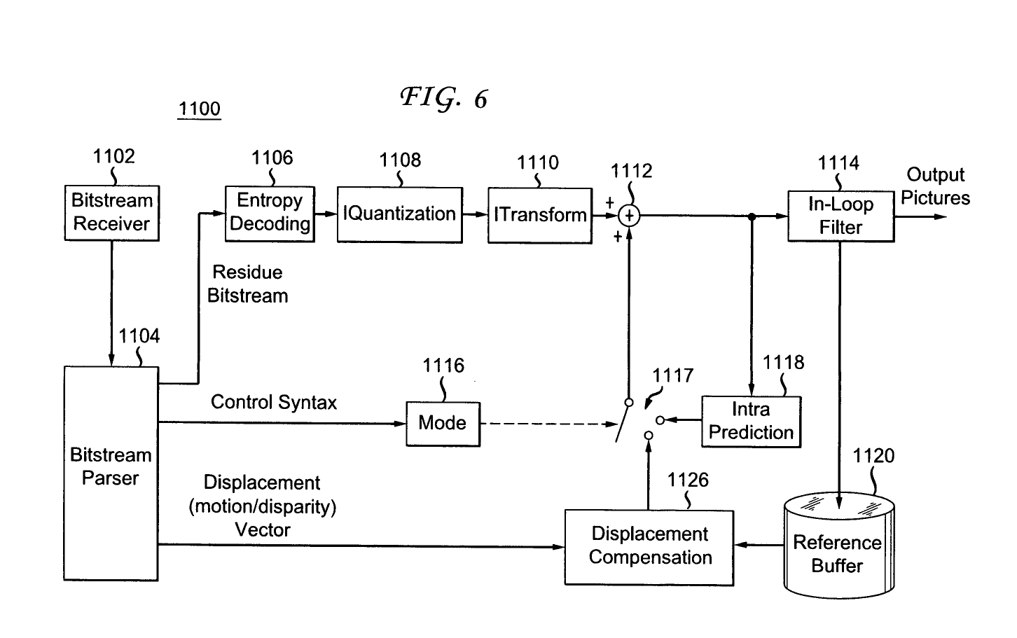

Referring to FIG. 6, a decoder 1100 depicts an implementation of a decoder that may be used to decode images and provide them to, for example, a device for determining if the images are from a camera pair that is converging or parallel. The decoder 1100 may also be used to decode, for example, metadata indicating whether images are from a camera pair that is converging or parallel. The decoder 1100 may be implemented as part of a video receiving system as described below with respect to FIG. 8.

The decoder 1100 can be configured to receive a bitstream using bitstream receiver 1102, which in turn is in signal communication with bitstream parser 1104 and provides the bitstream to parser 1104. The bit stream parser 1104 can be configured to transmit a residue bitstream to entropy decoder 1106, transmit control syntax elements to mode selection module 1116, and transmit displacement (motion/disparity) vector information to displacement compensation module 1126. The inverse quantization module 1108 can be configured to perform inverse quantization on an entropy decoded signal received from the entropy decoder 1106. In addition, the inverse transform module 1110 can be configured to perform an inverse transform on an inverse quantized signal received from inverse quantization module 1108 and to output the inverse transformed signal to adder or combiner 1112.

Adder 1112 can receive one of a variety of other signals depending on the decoding mode employed. For example, the mode decision module 1116 can determine whether displacement compensation or intra prediction encoding was performed on the currently processed block by the encoder by parsing and analyzing the control syntax elements. Depending on the determined mode, mode selection control module 1116 can access and control switch 1117, based on the control syntax elements, so that the adder 1112 can receive signals from the displacement compensation module 1126 or the intra prediction module 1118.

Here, the intra prediction module 1118 can be configured to, for example, perform intra prediction to decode a block or slice using references to the same block or slice currently being decoded. In turn, the displacement compensation module 1126 can be configured to, for example, perform displacement compensation to decode a block or a slice using references to a block or slice, of the same frame currently being processed or of another previously processed frame that is different from the block or slice currently being decoded.

After receiving prediction or compensation information signals, the adder 1112 can add the prediction or compensation information signals with the inverse transformed signal for transmission to an in-loop filter 1114, such as, for example, a deblocking filter. The in-loop filter 1114 can be configured to filter its input signal and output decoded pictures. The adder 1112 can also output the added signal to the intra prediction module 1118 for use in intra prediction. Further, the in-loop filter 1114 can transmit the filtered signal to the reference buffer 1120. The reference buffer 1120 can be configured to parse its received signal to permit and aid in displacement compensation decoding by element 1126, to which the reference buffer 1120 provides parsed signals. Such parsed signals may be, for example, all or part of various images.

Metadata may be included in a bitstream provided to the bitstream receiver 1102. The metadata may be parsed by the bitstream parser 1104, and decoded by the entropy decoder 1106. The decoded metadata may be extracted from the decoder 1100 after the entropy decoding using an output (not shown).

Referring now to FIG. 7, a video transmission system/apparatus 4300 is shown, to which the features and principles described above may be applied. The video transmission system 4300 may be, for example, a head-end or transmission system for transmitting a signal using any of a variety of media, such as, for example, satellite, cable, telephone-line, or terrestrial broadcast. The transmission may be provided over the Internet or some other network. The video transmission system 4300 is capable of generating and delivering, for example, video content and other content such as, for example, indicators of depth including, for example, depth and/or disparity values.

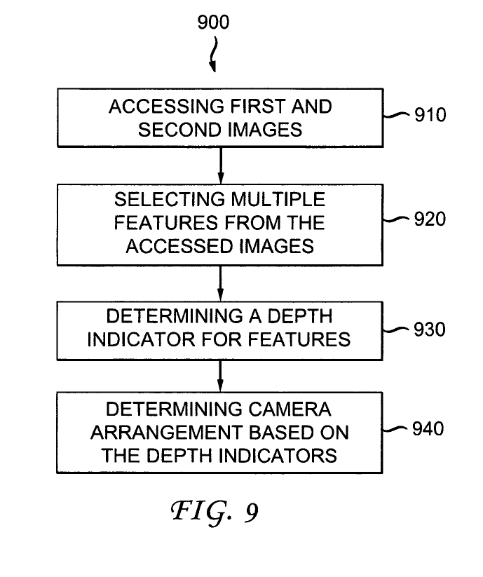

The video transmission system 4300 receives input video from a processing device 4301. The processing device 4301 is, in one implementation, a processor configured for determining from video images whether cameras are parallel or converging. Various implementations of the processing device 4301 include, for example, processing devices implementing the algorithms of FIG. 3 or 9. The processing device 4301 may also provide metadata to the video transmission system 4300 indicating whether cameras are parallel or converging.

The video transmission system 4300 includes an encoder 4302 and a transmitter 4304 capable of transmitting the encoded signal. The encoder 4302 receives video information, which may include, for example, images and depth indicators, and generates an encoded signal(s) based on the video information. The encoder 4302 may be, for example, one of the encoders described in detail above. The encoder 4302 may include sub-modules, including for example an assembly unit for receiving and assembling various pieces of information into a structured format for storage or transmission. The various pieces of information may include, for example, coded or uncoded video, coded or uncoded depth indicators and/or information, and coded or uncoded elements such as, for example, motion vectors, coding mode indicators, and syntax elements.

The transmitter 4304 may be, for example, adapted to transmit a program signal having one or more bitstreams representing encoded pictures and/or information related thereto. Typical transmitters perform functions such as, for example, one or more of providing error-correction coding, interleaving the data in the signal, randomizing the energy in the signal, and modulating the signal onto one or more carriers using modulator 4306. The transmitter 4304 may include, or interface with, an antenna (not shown). Further, implementations of the transmitter 4304 may include, or be limited to, a modulator.

Referring now to FIG. 8, a video receiving system/apparatus 4400 is shown to which the features and principles described above may be applied. The video receiving system 4400 may be configured to receive signals over a variety of media, such as, for example, satellite, cable, telephone-line, or terrestrial broadcast. The signals may be received over the Internet or some other network.

The video receiving system 4400 may be, for example, a cell-phone, a computer, a set-top box, a television, or other device that receives encoded video and provides, for example, decoded video for display to a user or for storage. Thus, the video receiving system 4400 may provide its output to, for example, a screen of a television, a computer monitor, a computer (for storage, processing, or display), or some other storage, processing, or display device.

The video receiving system 4400 is capable of receiving and processing video content including video information. The video receiving system 4400 includes a receiver 4402 capable of receiving an encoded signal, such as for example the signals described in the implementations of this application, and a decoder 4406 capable of decoding the received signal.

The receiver 4402 may be, for example, adapted to receive a program signal having a plurality of bitstreams representing encoded pictures. Typical receivers perform functions such as, for example, one or more of receiving a modulated and encoded data signal, demodulating the data signal from one or more carriers using a demodulator 4404, de-randomizing the energy in the signal, de-interleaving the data in the signal, and error-correction decoding the signal. The receiver 4402 may include, or interface with, an antenna (not shown). Implementations of the receiver 4402 may include, or be limited to, a demodulator.

The decoder 4406 outputs video signals including, for example, video information. The decoder 4406 may be, for example, the decoder 1100 described in detail above. The output video from the decoder 4406 is provided, in one implementation, to a processing device such as, for example, the processing device 4301 as described above with respect to FIG. 7.

Referring to FIG. 9, a process 900 is depicted that provides another implementation for determining a camera arrangement. The process 900 includes accessing a first image and a second image (910). The first and second images form a stereo image pair. The first image has been captured from a first camera, and the second image has been captured from a second camera. The first and second cameras were in either a parallel arrangement or a converging arrangement.

The process 900 includes selecting multiple features that exist in the first image and in the second image (920), and determining an indicator of depth for each of the multiple features (930).

The process 900 includes determining whether the first camera and the second camera were arranged in the parallel arrangement or the converging arrangement based on the values of the determined depth indicators (940).

Various implementations refer to “images”, “video”, or “frames”. Such implementations may, more generally, be applied to “pictures”, which may include, for example, any of various video components or their combinations. Such components, or their combinations, include, for example, luminance, chrominance, Y (of YUV or YCbCr or YPbPr), U (of YUV), V (of YUV), Cb (of YCbCr), Cr (of YCbCr), Pb (of YPbPr), Pr (of YPbPr), red (of RGB), green (of RGB), blue (of RGB), S-Video, and negatives or positives of any of these components. A “picture” may also refer, for example, to a frame, a field, or an image. The term “pictures” may also, or alternatively, refer to various different types of content, including, for example, typical two-dimensional video, a disparity map for a 2D video picture, or a depth map that corresponds to a 2D video picture.

Reference to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, identifying the information, or retrieving the information from memory.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C” and “at least one of A, B, or C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

One or more implementations having particular features and aspects are thereby provided. However, variations of these implementations and additional applications are contemplated and within our disclosure, and features and aspects of described implementations may be adapted for other implementations.

For example, these implementations may be extended to apply to groups of three or more pictures. These implementations may also be extended to apply to different indicators of depth besides, or in addition to, disparity. One such indicator of depth is the actual depth value. It is also well-known that the actual depth values and disparity values are directly derivable from each other based on camera parameters using the following equation which shows that disparity is inversely-proportionally related to scene depth:

$$D = \frac{f \cdot b}{d} \qquad ( 6 )$$

where D describes depth, b is baseline between two stereo-image cameras, f is the focal length for each camera, and d is the disparity for two corresponding feature points. Equation (6) above is valid for parallel cameras with the same focal length. More complicated formulas can be defined for other scenarios but in most cases Equation (6) can be used as an approximation. Additionally, camera parameters include intrinsic parameters such as focus, and also include extrinsic parameters such as the camera pose information. The relative pose between two cameras, such as, for example, rotation angles and baseline (distance between centers of cameras) will affect the conversion.

The present principles may also be used in the context of coding video and/or coding other types of data. Additionally, these implementations and features may be used in the context of, or adapted for use in the context of, a standard. Several such standards are H.264/MPEG-4 AVC (AVC), the extension of AVC for multi-view coding (MVC), the extension of AVC for scalable video coding (SVC), and the proposed MPEG/JVT standards for 3-D Video coding (3DV) and for High-Performance Video Coding (HVC), but other standards (existing or future) may be used. Of course, the implementations and features need not be used in a standard.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding and decoding. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette, a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this disclosure and are within the scope of this disclosure.

The following list provides a list of various implementations. The list is not intended to be exhaustive but merely to provide a description of some of the many possible implementations.

1. A method comprising:
accessing a first image and a second image that form a stereo image pair, the first image having been captured from a first camera, and the second image having been captured from a second camera in either a parallel arrangement or a converging arrangement with the first camera;
selecting multiple features that exist in the first image and in the second image, wherein selecting the multiple features comprises:
using a feature selection process to select candidate features in the first image and candidate features in the second image, and
using a feature matching process to determine which of the candidate features in the first image match candidate features in the second image;
determining an indicator of depth for each of the multiple features; and
determining whether the first camera and the second camera were arranged in the parallel arrangement or the converging arrangement based on values of the determined indicators of depth.

2. The method of claim 1 wherein determining whether the first camera and the second camera were arranged in the parallel arrangement or the converging arrangement is based on whether the values of the determined depth indicators are greater than zero or less than zero

3. The method of claim 1 wherein the determined indicator of depth comprises a depth value or a disparity value for a pixel in either the first image or the second image.

4. The method of claim 1 wherein:
the determined indicator of depth comprises a disparity value for each of the multiple features, and
determining whether the first camera and the second camera were arranged in the parallel arrangement or the converging arrangement comprises determining that (i) the first camera and the second camera were arranged in the parallel arrangement if the disparity value is greater than zero for each of the multiple features or if the disparity value is less than zero for each of the multiple features, and (ii) the first camera and the second camera were arranged in the convergent arrangement if the disparity value is greater than zero for at least a first of the multiple features and the disparity value is less than zero for at least a second of the multiple features.

5. The method of claim 1 wherein selecting the multiple features comprises including (i) a far feature that is far from at least one of the first camera and the second camera and (ii) a near feature that is near at least one of the first camera and the second camera.

6. (canceled)

7. The method of claim 1 wherein selecting the multiple features comprising:
using a feature selection process to select candidate features in the first image; and
using a feature tracking process to determine candidate features in the second image that match the candidate features in the first image.

8. The method of claim 1 wherein:
selecting the multiple features comprises determining a set of quality features from the selected multiple features, based on whether the multiple features satisfy a quality condition, and
determining whether the first camera and the second camera were arranged in the parallel arrangement or the converging arrangement is based on the values of the determined depth indicators for the set of quality features.

9. The method of claim 8 wherein the quality condition comprises one or more of (i) a threshold confidence score in a feature matching process, or (ii) a threshold confidence score in a determined indicator of depth.

10. The method of claim 8 wherein determining whether the first camera and the second camera were arranged in the parallel arrangement or the converging arrangement is based on whether values of the determined depth indicators for the set of quality features are greater than zero or less than zero.

11. The method of claim 1 wherein selecting the multiple features comprises:
selecting at least a threshold number of features, but less than all of the features that exist in the first image and in the second image, wherein the selected features are selected without regard to whether the features are in the foreground or the background.

12. The method of claim 11 wherein selecting at least the threshold number of features comprises selecting a sufficiently large number of features such that it is expected that some of the selected features will be in the foreground and some of the selected features will be in the background.

13. An apparatus comprising:
means for accessing a first image and a second image that form a stereo image pair, the first image having been captured from a first camera, and the second image having been captured from a second camera in either a parallel arrangement or a converging arrangement with the first camera;
means for selecting multiple features that exist in the first image and in the second image, wherein selecting the multiple features comprises:
using a feature selection process to select candidate features in the first image and candidate features in the second image, and
using a feature matching process to determine which of the candidate features in the first image match candidate features in the second image;
means for determining an indicator of depth for each of the multiple features; and
means for determining whether the first camera and the second camera were arranged in the parallel arrangement or the converging arrangement based on the values of the determined indicators of depth.

14. An apparatus, comprising one or more devices configured to perform at least the following:
accessing a first image and a second image that form a stereo image pair, the first image having been captured from a first camera, and the second image having been captured from a second camera in either a parallel arrangement or a converging arrangement with the first camera;
selecting multiple features that exist in the first image and in the second image, wherein selecting the multiple features comprises:
using a feature selection process to select candidate features in the first image and candidate features in the second image, and
using a feature matching process to determine which of the candidate features in the first image match candidate features in the second image;
determining an indicator of depth for each of the multiple features; and
determining whether the first camera and the second camera were arranged in the parallel arrangement or the converging arrangement based on the values of the determined indicators of depth.

15. The apparatus of claim 14 wherein the one or more devices comprises (i) one or more processors, (ii) one or more encoders, or (iii) one or more decoders.

16. The apparatus of claim 14 wherein the one or more devices comprises one or more of a set-top box, a cell-phone, a computer, or a PDA.

17. A processor readable medium having stored thereon instructions for causing a processor to perform at least the following:
accessing a first image and a second image that form a stereo image pair, the first image having been captured from a first camera, and the second image having been captured from a second camera in either a parallel arrangement or a converging arrangement with the first camera;
selecting multiple features that exist in the first image and in the second image, wherein selecting the multiple features comprises:
using a feature selection process to select candidate features in the first image and candidate features in the second image, and
using a feature matching process to determine which of the candidate features in the first image match candidate features in the second image;
determining an indicator of depth for each of the multiple features; and
determining whether the first camera and the second camera were arranged in the parallel arrangement or the converging arrangement based on the values of the determined indicators of depth.

18. The apparatus of claim 14 further comprising:
a demodulator configured to demodulate a signal including the first image and the second image.

19. The apparatus of claim 14 further comprising:
a modulator configured to modulate a signal including an encoding of the first image and an encoding of the second image.
